(19) United States
(12) Patent Application Publication
(10) Pub. No.: US 2009/0060281 A1
(43) Pub. Date: Mar. 5, 2009

(54) Object Distance Deriving Device

(75) Inventors: Jun TANIDA, Suita-shi (JP); Takashi Toyoda, Daito-shi (JP); Yoshizumi Nakao, Daito-shi (JP); Yasuo Masaki, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignees: Funai Electric Co., Ltd., Daito-shi (JP); Osaka University, Suita-shi (JP)

(21) Appl. No.: 12/261,706

(22) Filed: Oct. 30, 2008

Related U.S. Application Data
(60) Provisional application No. 60/986,117, filed on Nov. 7, 2007.

(30) Foreign Application Priority Data
Mar. 26, 2007 (JP) 2007-079880

(51) Int. Cl. G06K 9/00

(52) U.S. Cl. 382/106

(57) ABSTRACT

An object distance deriving device comprises a compound-eye imaging unit for capturing n unit images and a microprocessor for calculating an object distance of an object from the imaging unit based on the unit images. The microprocessor sets a first temporary distance D1 from discrete temporary distances D1-Dn prepared in advance, and rearranges pixels of each unit image at D1 to create one reconstructed image. The microprocessor reversely projects the pixels of each unit image at D1 to create n reverse projection images. The microprocessor calculates and sums n deviations each between a pixel of the reconstructed image and that of each reverse projection image at each xy coordinate position to calculate an evaluation value for D1. The microprocessor repeats this process for the temporary distances D2-Dn to obtain n evaluation values. The microprocessor determines one of the temporary distances D1-Dn giving a minimum evaluation value as the object distance.

### BACKGROUND OF THE INVENTION

1. Field of the Invention

The present invention relates to an object distance deriving device, and more particularly to an object distance deriving device which uses imaging means and derives a distance of an object from the imaging means based on images captured by the imaging means.

2. Description of the Related Art

An image reconstruction device is known which reconstructs a single two-dimensional image by digital image processing of multiple unit images of a three-dimensional object as captured by a compound-eye camera having multiple microlenses (refer, for example, to Japanese Laid-open Patent Publication 2005-167484). The compound-eye camera has an advantage that it can be manufactured to be thin, and also can obtain a bright image easily. However, at the same time it has a disadvantage that the definition (resolution) of each captured unit image is low. In order to increase the definition of the images in the image processing to reconstruct a single image, various methods have been developed. The above-described Japanese Laid-open Patent Publication 2005-167484 discloses a pixel rearrangement method which is one of the methods for reconstructing a single image with high definition from multiple unit images. In the following, a brief description of an image forming device described in Japanese Laid-open Patent Publication 2005-167484 will be made with reference to FIG. 12 and FIG. 13, in which FIG. 12 is a schematic block diagram of an image forming device shown in this patent publication, while FIG. 13 is a schematic view showing a process performed by the image forming device to form an image.

As shown in FIG. 12, an image forming device 100 described therein is composed of a compound-eye camera 101 having an array of microlenses and a processor 102 for processing images captured by the compound-eye camera 101. Further, as shown in FIG. 13, the processor 102 rearranges, in one same area M, pixels of unit images Q1, Q2, Q3 captured by the compound-eye camera 101 with parallax between the pixels of the unit images Q1, Q2, Q3 due to the difference in position in the optical lenses, such that the pixels of each of the unit images Q1, Q2, Q3 are slightly shifted from those of the others by an amount corresponding to a shift amount (shift in relative position between the respective unit images) so as to correct the parallax therebetween. More specifically, to rearrange the pixels of the respective unit images Q1, Q2, Q3 in the same area M, the image forming device 100 calculates the shift amount based on a correlation function among the unit images Q1, Q2, Q3.

In the image processing (digital processing) of the captured images of a three-dimensional object to reconstruct therefrom a predetermined two-dimensional image as described above, there may be a need for distance information between the object and the imaging means. In this case, it is desirable that the method for obtaining the distance information is performed in a short time, in which the calculation e.g. of accompanying parameters is simple or not required, and the obtained distance information is accurate. However, Japanese Laid-open Patent Publication 2005-167484 only describes a calculation method using multiple parameters such as lens-to-lens distance of the array of microlenses and focal length regarding the method of calculating the distance between the compound-eye camera and an object to be captured, although the image forming device of this patent publication can easily obtain multiple images from different viewpoints because it uses a compound-eye camera. It does not describe a method for accurately deriving a distance between an object and the imaging means by a simple calculation in a short time.

There are other known methods or devices in this connection. For example, Japanese Patent 3575178 discloses a method to derive a distance to an object (to be imaged) by using parallax between images of the object based on the principle of triangulation so as to detect an existence range of the object. Furthermore, Japanese Laid-open Patent Publication Hei 9-187038 discloses a three-dimensional shape extraction device which derives a distribution of distances to an object (to be imaged) based on multiple images captured by a camera moving relative to the object, and which creates a two-dimensional image based on the derived distance distribution. However, the distance calculation methods and devices based on the principle of triangulation as used in Japanese Patent 3575178 and Japanese Laid-open Patent Publication Hei 9-187038 require a preliminary calculation of parameters such as moving amount of viewpoint. In particular, in the device described in Japanese Laid-open Patent Publication Hei 9-187038, a shutter is opened and closed multiple times as the camera moves so as to obtain multiple images from different viewpoints.

Thus, there are problems that the moving amount of viewpoint is required to be calculated each time an image is captured, and that it takes a long time to derive the distance between the object and the imaging means. In other words, according to these patent publications, it is not possible to accurately derive the object distance by a simple calculation in a short time. Besides, as disclosed in Japanese Laid-open Patent Publication 2001-167276, an imaging device is known in which a distance sensor is used to measure a distribution of multiple distances, and an image area of an image captured by a CCD (Charge Coupled Device) is divided into area segments respectively corresponding to the multiple distances based on the distribution of distances, so as to create a predetermined synthetic image. However, the imaging device of this patent publication does not make it possible to accurately derive the object distance by a simple calculation in a short time.

### SUMMARY OF THE INVENTION

An object of the present invention is to provide an object distance deriving device which uses imaging means and derives a distance of an object (object distance) from the imaging means based on images captured by the imaging means, and which can accurately derive the object distance by a simple calculation in a short time.

According to the present invention, this object is achieved by an object distance deriving device comprising imaging means for capturing images of an object and distance calculating means for calculating a distance (hereafter referred to as “object distance”) of the object from the imaging means based on the images of the object captured by the imaging means, wherein the imaging means has an optical imaging system for imaging n unit images each formed of pixels where n is an integer of at least 2, and wherein the distance calculating means comprises: distance setting means for temporarily setting a plurality of object distances between the object and the imaging means as a plurality of temporary distances; reconstructed image creating means for rearranging the pixels forming each of the unit images on a plane located at a first one (hereafter referred to as “first temporary distance”) of the plurality of temporary distances from the imaging means as set by the distance setting means so as to create one reconstructed image on the plane located at the first temporary distance; and reverse projection image creating means for reversely projecting, unit image-by-unit image, the pixels forming each of the unit images on the plane located at the first temporary distance so as to create n reverse projection images on the plane located at the first temporary distance.

The distance calculating means further comprises: evaluation value calculating means for (a) calculating a deviation between a pixel at each predetermined xy coordinate position of the one reconstructed image and the pixel at the each predetermined xy coordinate position of each of the n reverse projection images to obtain n deviations for the pixel at the each predetermined xy coordinate position for the first temporary distance, and (b) summing the n deviations to calculate an evaluation value for the pixel at the each predetermined xy coordinate position for the first temporary distance; repeating means for allowing the reconstructed image creating means, the reverse image creating means and the evaluation value calculating means to repeat, for each subsequent one of the plurality of temporary distances, the creation of a further reconstructed image of the n unit images, the creation of further n reverse projection images of the n unit images, and the calculation of a further evaluation value for the pixel at the each predetermined xy coordinate position, respectively, so as to obtain a plurality of evaluation values for the pixel at the each predetermined xy coordinate position for the plurality of temporary distances; and distance determining means for determining, as the object distance for the pixel at the each predetermined xy coordinate position from the imaging means, one of the first and the subsequent temporary distances which gives a minimum evaluation value among the plurality of evaluation values for the pixel at the each predetermined xy coordinate position.

According to the object distance deriving device of the present invention as thus described, n unit images are obtained by the optical imaging system. One reconstructed image and n reverse projection images are created from n unit images based on each of temporary distances between an object and the imaging means as set by the distance setting means. The distance calculating means calculates deviations each between a pixel of the thus created reconstructed image and that of each of the thus created n reverse projection images with respect to each temporary distance, and sums the thus calculated deviations as an evaluation value for the pixel with respect to the each temporary distance. One of the evaluation values for the pixel with respect to all the temporary distances, which gives a minimum evaluation value, is determined as an object distance between the object and the imaging means. This makes it possible to accurately derive the object distance by a simple calculation in a short time.

Preferably, the distance calculating means further comprises smoothing means for smoothing the plurality of evaluation values for the pixel at the each predetermined xy coordinate position for the plurality of temporary distances as calculated by the evaluation value calculating means, wherein the distance determining means determines the object distance for the pixel at the each predetermined xy coordinate position from the imaging means based on the plurality of evaluation values as smoothed by the smoothing means. This preferred object distance deriving device smooths the evaluation values for each pixel with respect to each temporary distance, so that the distribution of the evaluations values on the XY plane becomes smooth, making it possible to derive the object distance more accurately.

Further preferably, the reconstructed image creating means creates n high-frequency component unit images by extracting a high-frequency component from each of the n unit images, and creates one high-frequency component reconstructed image from the thus created n high-frequency component unit images, wherein the reverse projection image creating means creates n high-frequency component unit images by extracting a high-frequency component from each of the n unit images, and creates n high-frequency component reverse projection images from the thus created n high-frequency component unit images, and wherein the evaluation value calculating means calculates the evaluation values based on the one high-frequency component reconstructed image and the n high-frequency component reverse projection images. This further preferred object distance deriving device calculates the evaluation values based on the one high-frequency component reconstructed image and the n high-frequency component reverse projection images, all of which are created using the high-frequency component of each of the n unit images, so that the low-frequency noise in each unit image is eliminated, and thus the object distance can be derived more accurately.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic view, partly in block form, of an object distance deriving device according to a first embodiment of the present invention;

FIG. 2A is a schematic perspective view for explaining a positional relationship between an object, an optical lens array and unit images in the object distance deriving device;

FIG. 2B is a schematic plan view for explaining a positional relationship between the object, the optical lens array and two unit images as representative examples of the unit images;

FIG. 3 is a flow chart showing a step of calculating an object distance as performed by the object distance deriving device;

FIG. 4 is a schematic perspective view for explaining the principle of creating a reconstructed image in the object distance deriving device;

FIG. 5 is an explanatory view for explaining the principle of creating the reconstructed image in the object distance deriving device;

FIG. 6 is a schematic perspective view for explaining the principle of creating reverse projection images in the object distance deriving device;

FIG. 7 is an explanatory view for explaining the principle of creating the reverse projection images in the object distance deriving device;

FIG. 8 is an explanatory view for explaining a group of evaluation values stored in a memory;

FIG. 9 is a schematic view showing an example of unit images captured by a compound-eye imaging unit in the object distance deriving device;

FIG. 10 is a schematic view showing an example of a reconstructed image when one temporary distance is set in the object distance deriving device;

FIG. 11 is a schematic view showing an example of a distance image as derived in the object distance deriving device;

FIG. 12 is a schematic block diagram of a conventional image forming device; and

FIG. 13 is a schematic view showing a process performed by the conventional image forming device to reconstruct an image.

### DESCRIPTION OF THE PREFERRED EMBODIMENTS

Embodiments of the present invention, as best mode for carrying out the invention, will be described hereinafter with reference to the drawings.

The present invention relates to an object distance deriving device. It is to be understood that the embodiments described herein are not intended as limiting, or encompassing the entire scope of, the present invention. Note that like parts are designated by like reference numerals, characters or symbols throughout the drawings.

### First Embodiment

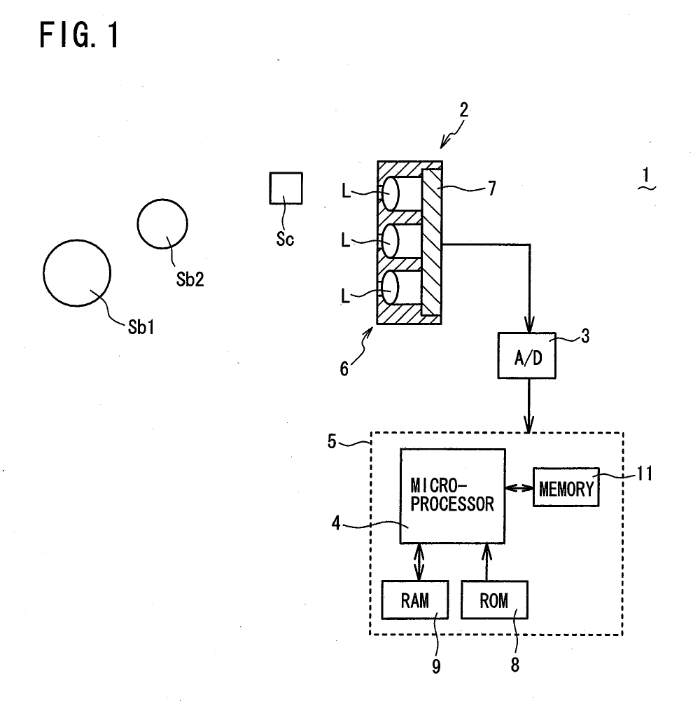

Referring to FIG. 1 to FIG. 11, an object distance deriving device 1 according to a first embodiment of the present invention will be described. FIG. 1 is a schematic view, partly in block form, of an object distance deriving device 1 of the present embodiment. As shown in FIG. 1, the object distance deriving device 1 comprises a compound-eye imaging unit 2 (claimed “imaging means”) and a distance calculation unit 5 (claimed “distance calculating means”) mainly composed of a microprocessor 4 for receiving, via an A/D (Analog-to-Digital) converter 3, image information captured by the compound-eye imaging unit 2, and for calculating a distance (object distance) between an object and the compound-eye imaging unit 2 (more specifically optical lens array 6) based on the received and digitized image information. As will be apparent from the description below, the microprocessor 4 serves as claimed “distance calculating means”, “distance setting means”, “reconstructed image creating means”, “reverse projection image creating means”, “evaluation value calculating means”, “repeating means”, “distance determining means” and “smoothing means”.

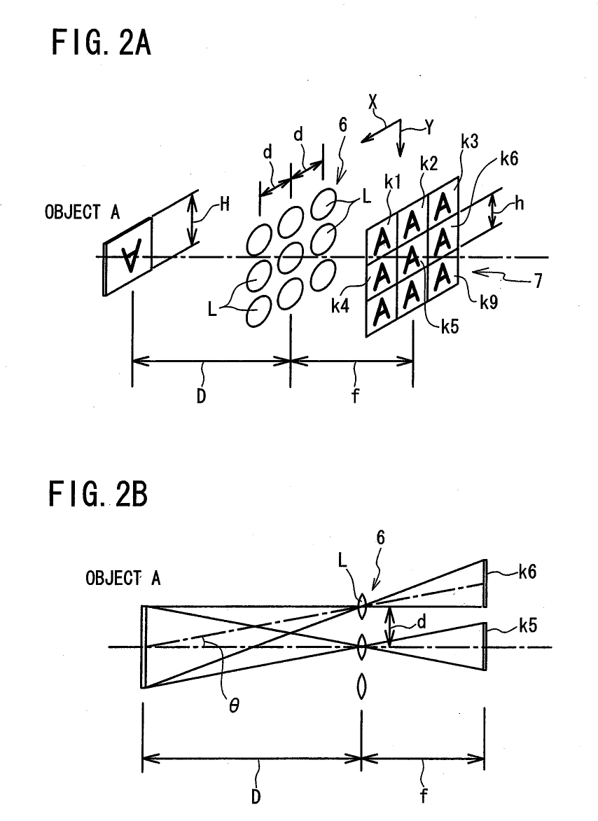

FIG. 2A is a schematic perspective view for explaining a positional relationship between an object A, an optical lens array 6 and unit images k1 to k9 in the object distance deriving device 1. Referring to FIG. 1 and FIG. 2A, the compound-eye imaging unit 2 has an optical imaging system comprising: an optical lens array 6 formed of nine optical lenses L (the number of optical lenses L, which can be represented by n where n is an integer of at least 2, is nine in the present embodiment, and is actually preferred to be larger) arranged in a matrix array of three rows and three columns on the same plane; and a solid-state imaging element 7 formed of a CMOS (Complementary Metal Oxide Semiconductor) image sensor for capturing or imaging nine unit images k1 to k9 formed at the focal points of the respective optical lenses L. As shown in FIG. 1, the distance calculation unit 5 comprises: a microprocessor 4; a ROM (Read Only Memory) 8 storing e.g. an operating program for the microprocessor 4 such as a distance calculation program; a RAM (Random Access Memory) 9 for temporarily storing e.g. image data; and a large capacity memory 11. Based on the distance calculation program, the microprocessor 4 processes image information of the unit images k1 to k9 received from the compound-eye imaging unit 2, so as to calculate the distance (object distance) between the object and the compound-eye imaging unit 2.

FIG. 2B is a schematic plan view for explaining a positional relationship between the object A, the optical lens array 6 and two unit images k5 and k6 as representative examples of the unit images k1 to k9 in the object distance deriving device 1. Referring now to FIGS. 2A and 2B, the relationships, including the positional relationship, between the optical lens array 6, the object A placed in front of the optical lens array 6, and the unit images k1 to k9 formed on the solid-state imaging element 7 by the respective lenses L will be described. For convenience of description, the object A is assumed to be a plate placed parallel to XY plane (two-dimensional plane) in FIG. 2A and having an inverted letter “A” drawn thereon. The optical lens array 6 and the solid-state imaging element 7 are also placed parallel to the XY plane.

The nine optical lenses L respectively collect light from the object A on the solid-state imaging element 7 to form nine unit images k1 to k9 of the object A in a matrix of three rows and three columns. Here, the relation h=H×f/D holds where D is the distance (object distance) from the object A to the optical lens array 6, f is the distance (focal length) from the optical lens array 6 to the solid-state imaging element 7, H is the vertical length (size) of the object A, and h is the vertical length (size) of each of the unit images k1 to k9. Actually, the focal length f of the compound-eye imaging unit 2 has an extremely small value, so that the size h of each unit image also has a small value.

Further, the unit images k1 to k9 are images having parallaxes therebetween. For example, the unit image k5 formed by the central optical lens L is different in viewpoint (shifted left and right) from the unit images k4, k6 each by a distance d between the optical lenses L, since the unit images k4, k6 are formed by the optical lenses L which are positioned left and right of the central optical lens L at the distance d. As apparent from FIG. 2B, which representatively shows the unit image k6 relative to the unit image k5, the unit images k4, k6 have a parallax angle θ left and right relative to each other from the unit image k5, satisfying the relation tan θ=d/D. The nine unit images k1 to k9 have parallaxes based on this relation. Due to the parallax effect, the image of the object A is differently shifted in position in the nine unit images k1 to k9. As will be described later, the parallax effect is corrected when rearranging the unit images k1 to k9 to form a reconstructed image.

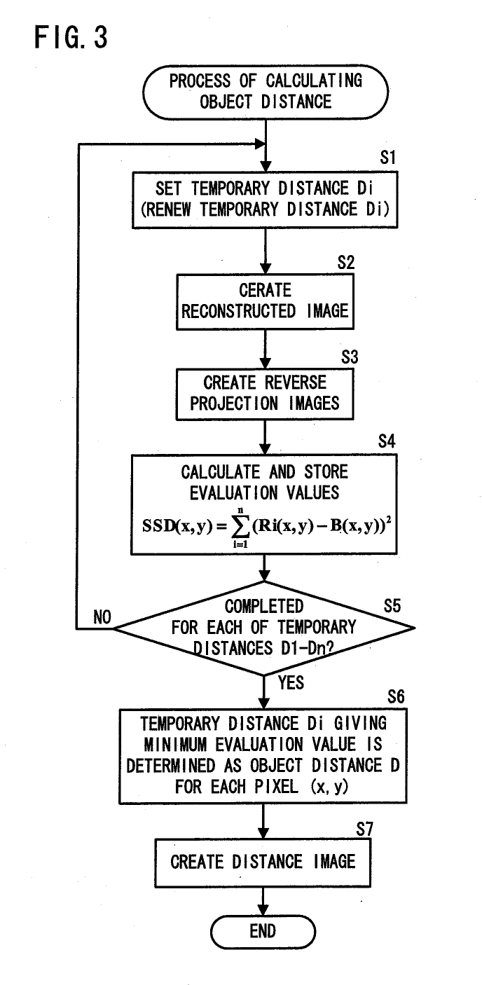

Next, referring to the flow chart of FIG. 3, the process of object distance calculation as performed by the microprocessor 4 in the object distance deriving device 1 of the first embodiment will be described. The object distance deriving device 1 is here assumed to be in a state where nine unit images k1 to k9 of an object A which the microprocessor 4 obtains as digital image information from those captured by the solid-state imaging element 7 are stored e.g. in the memory 11, in which the object distance D between the optical lens array 6 and the object A is unknown. First, the microprocessor 4 reads a first temporary distance D1 (first predetermined distance) from multiple preset temporary distances D1 to Dn, and sets the temporary distance D1 (S1).

Here, the temporary distances D1 to Dn are candidates of the object distance D from the optical lens array 6 to the object, and are prepared or stored in advance in the ROM 8 or the memory 11 as discrete values. An object (to be captured) located farther from the optical lens array 6 gives a smaller parallax angle θ, making it more difficult to determine the object distance based on the shift between the unit images. Thus, actually, a relatively large number of temporary distances are set at relatively short intervals for a closer range (closer distance area) to the optical lens array 6, whereas a relatively small number of temporary distances are set at relatively long intervals for a farther range (farther distance area) from the optical lens array 6. For example, the temporary distances D1 to Dn can be discrete values u defined by the exponential function u=a^{v}.

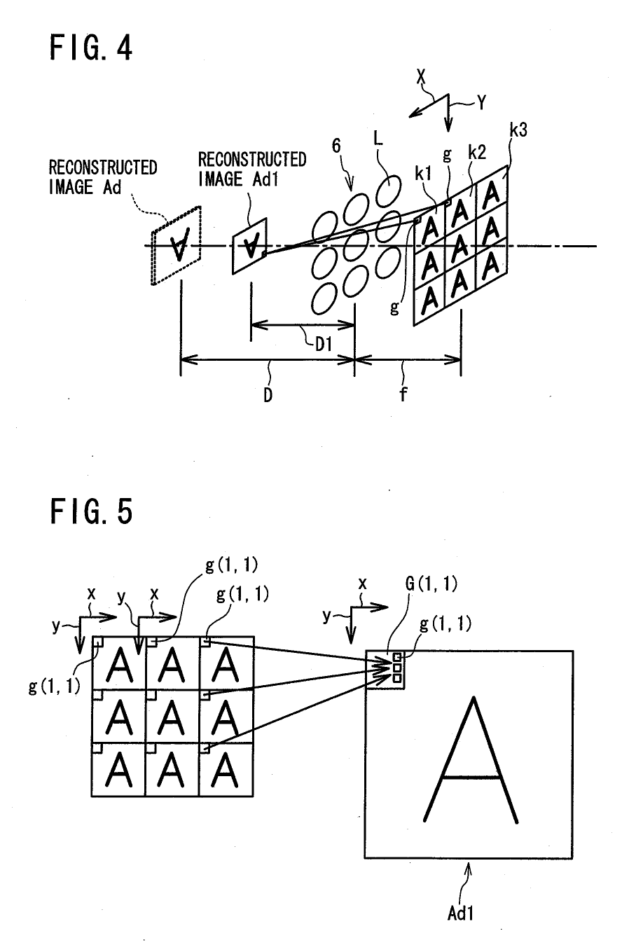

Next, based on the temporary distance D1 as set above, the microprocessor 4 creates one reconstructed image from the nine stored unit images k1 to k9 (S2). The process of creating the reconstructed image can be performed by a similar image rearrangement method as described in Japanese Laid-open Patent Publication 2005-167484. Referring now to FIG. 4 and FIG. 5, the process of creating a reconstructed image will be described. FIG. 4 and FIG. 5 are a schematic perspective view and an explanatory view for explaining the principle of creating the reconstructed image in the object distance deriving device 1 of the present embodiment. As shown in FIG. 4 and FIG. 5, the microprocessor 4 rearranges, pixel-by-pixel, the nine unit images k1 to k9 into one reconstructed image Ad1 on a plane (hereafter referred to as “temporary distance plane”) located at the first temporary distance D1 from the optical lens array 6 in a manner that the digital values of pixels g positioned at the same coordinate position on the xy coordinate plane of each of the unit images k1 to k9 are projected onto an area G (corresponding to each pixel g) of the temporary distance plane. In the description below, the coordinate of each of the unit images k1 to k9 is represented by the xy coordinate in order to distinguish from the two-dimensional XY plane.

More specifically, the microprocessor 4 creates the reconstructed image Ad1 as follows. The microprocessor 4 performs a first pixel rearrangement step such that the pixels g(1, 1) positioned at a coordinate (x=1, y=1) of the respective unit images k1 to k9 are rearranged on the temporary distance plane located at the first temporary distance D1, correcting the parallax in the unit images k1 to k9 based on the relation tan θ=d/D, which can be correspondingly expressed by tan θ1=d/D1 here, as if the lights from the object A collected on the solid-state imaging element 7 along the light collection paths via respective optical lenses L to form the unit images k1 to k9 return along the same light collection paths to the object A, respectively. Next, the microprocessor 4 performs a second pixel rearrangement step such that the pixels g(2,1) positioned at a coordinate (x=2, y=1) of the respective unit images k1 to k9 are rearranged on the temporary distance plane located at the first temporary distance D1, correcting the parallax in the unit images k1 to k9 in the same manner as for the pixels g(1, 1). By repeating the subsequent pixel rearrangement steps until all the pixels g(x,y) are rearranged on the temporary distance plane in this way, the reconstructed image Ad1 is created.

In the reconstructed image as thus created, an area G(x,y) corresponding to the pixels g(x,y) is formed as shown in FIG. 5. More specifically, the image in the area G(x,y) is formed by the pixels g(x,y) reflecting the parallax correction based on the parallax angle θ1 of the temporary distance D1 (tan θ1=d/D1) to compensate the shift amount (parallax) in the unit images k1 to k9. The thus created reconstructed image Ad1 is stored e.g. in the memory 11. Note that FIG. 4 shows a reconstructed image Ad by dashed lines, which is reconstructed on a plane located at the unknown object distance D. If the first temporary distance D1 is equal to the unknown object distance D, the reconstructed image as obtained has a high definition, while if the first temporary distance D1 is shifted from the unknown object distance D, the reconstructed image Ad1 has a lower definition than the reconstructed image Ad.

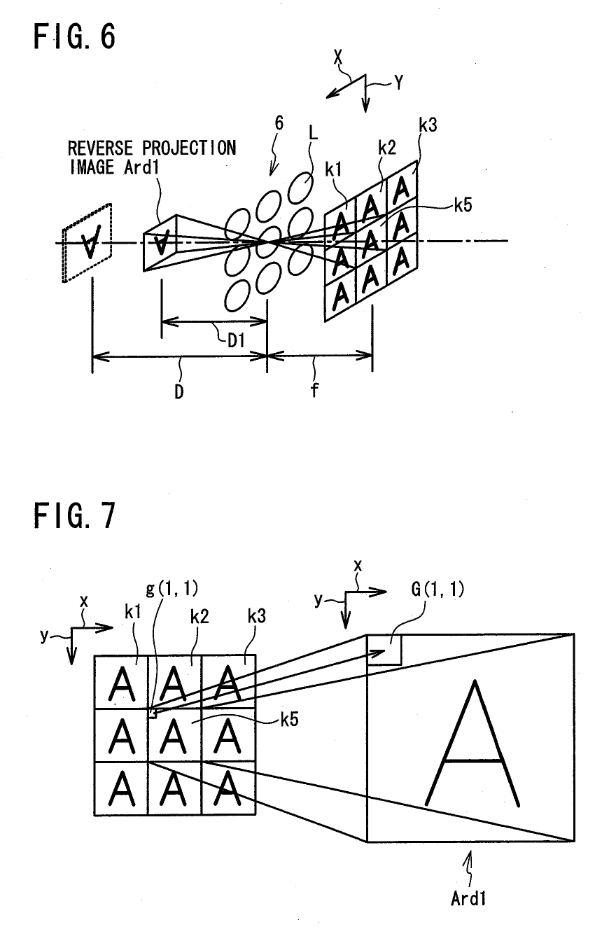

Next, based on the first temporary distance D1, the microprocessor 4 creates nine reverse projection images from the nine stored unit image k1 to k9 (S3). Referring to FIG. 6 and FIG. 7, the process of creating the reverse projection images will be described. FIG. 6 and FIG. 7 are a schematic perspective view and an explanatory view for explaining the principle of creating the reverse projection images in the object distance deriving device 1, in which the central unit image k5 is used as a representative example. As shown in FIG. 6 and FIG. 7, the microprocessor 4 creates a reverse projection image Ard of the unit image k5 on the temporary distance plane located at the first temporary distance D1 from the optical lens array 6 in a manner that the digital values of pixels g are projected pixel-by-pixel onto the temporary distance plane.

More specifically, the microprocessor 4 creates the reverse projection image Ard1 of the unit image k5 as follows. As shown in FIG. 7, the microprocessor 4 performs a first pixel projection step such that the pixel g(1, 1) positioned at a coordinate (x=1, y=1) of the unit image k5 is enlarged to the size of the reconstructed image Ad1 and projected onto the temporary distance plane located at the first temporary distance D1, as if the light from the object A collected on the solid-state imaging element 7 along the light collection path via the optical lens L to form the unit image k5 returns along the same light collection path toward the object A. Next, the microprocessor 4 performs a second pixel projection step such that the pixel g(2, 1) positioned at a coordinate (x=2, y=1) of the unit image k5 is enlarged and projected onto the temporary distance plane in the same manner as for the pixel g(1, 1).

By repeating the subsequent pixel projection steps until all the pixels g(x,y) of the unit image k5 are enlarged and projected onto the temporary distance plane in this way, the reverse projection image Ard is created. In the thus created reverse projection image Ard1, an area G(x,y) which corresponds to the pixel g(x,y) is formed of the one pixel g(x,y). The microprocessor 4 repeats the process of creating the projection image as described above for all the unit images k1 to k9, unit image-by-unit image, so as to create nine reverse projection images Ard1 which will be designated hereinafter by Ard11 to Ard19 although not shown. The reverse projection image of the unit image k5 as described above can be designated by Ard15. The nine reverse projection images Ard11 to Ard19 as thus created are stored e.g. in the memory 11.

Next, based on the one reconstructed image Ad1 and the nine reverse projection images Ard11 to Ard19 as created above, the microprocessor 4 calculates evaluation values for each pixel on the xy coordinate plane (S4). More specifically, an evaluation value SSD(x,y) is given by the following equation:

$$SSD ( x , y ) = {\sum }_{i = 1}^{n} {( Ri ( x , y ) - B ( x , y ) )}^{2}$$

In this equation, i represents the number of a unit image (as in i-th unit image ki), and Ri(x,y) represents the digital value of a pixel G at an xy coordinate position of a reverse projection image Ardi of the i-th unit image ki, while B(x,y) represents the digital value of a pixel G at an xy coordinate position of the reconstructed image Ad1, and n is the number of unit images which is 9 (nine) in the present embodiment.

More specifically, the microprocessor 4 calculates the square of the difference between the reconstructed image Ad1 and the reverse projection image Ard11 of the first unit image k1 for each pixel g on the xy coordinate plane so as to calculate a deviation of the reverse projection image Ard11 of the first unit image k1 from the reconstructed image Ad1. In the same way, the microprocessor 4 calculates the square of the difference between the reconstructed image Ad1 and the reverse projection image Ard12 of the second unit image k2 to calculate a deviation of the reverse projection image Ard12 of the second unit image k2 from the reconstructed image Ad1. By repeating the subsequent calculations in this way for all the reverse projection images Ard13 to Ard19, the microprocessor 4 obtains nine deviations. The microprocessor 4 sums the nine deviations to calculate or obtain the evaluation value SSD(x,y), which is stored e.g. in the memory 11.

Next, the microprocessor 4 repeats and completes the steps S1 to S4 for the second temporary distance D2 and subsequent temporary distances in the same manner as for the first temporary distance D1. More specifically, the microprocessor 4 determines whether the steps S1 to S4 for each of the temporary distances D1 to Dn (claimed “subsequent temporary distances” for those other than the “first temporary distance”) as set in S1 have been completed, using temporary distance planes (“subsequent temporary distance planes” for those other than the “first temporary distance plane” for D1) (S5). If not completed (NO in S5), the process goes back to the step S1 again to renew the temporary distance Di (S1). Normally, the process is performed in order of magnitude of the temporary distance, so that the renewal of the temporary distance Di is normally made from Di to D(i+1). In this case, a reconstructed image Ad(i+1) is created at a location farther from the optical lens array 6 than the reconstructed image Adi (S2). Then, nine reverse projection images Ardi1 to Ardi9 for the temporary distance D(i+1) are created, unit image-by-unit image, on a temporary distance plane (one of the “subsequent temporary distance planes”) (S3). Based on the nine reverse projection images Ardi1 to Ardi9, an evaluation value SSD(x,y) for the temporary distance D(i+1) is calculated, and is stored e.g. in the memory 11.

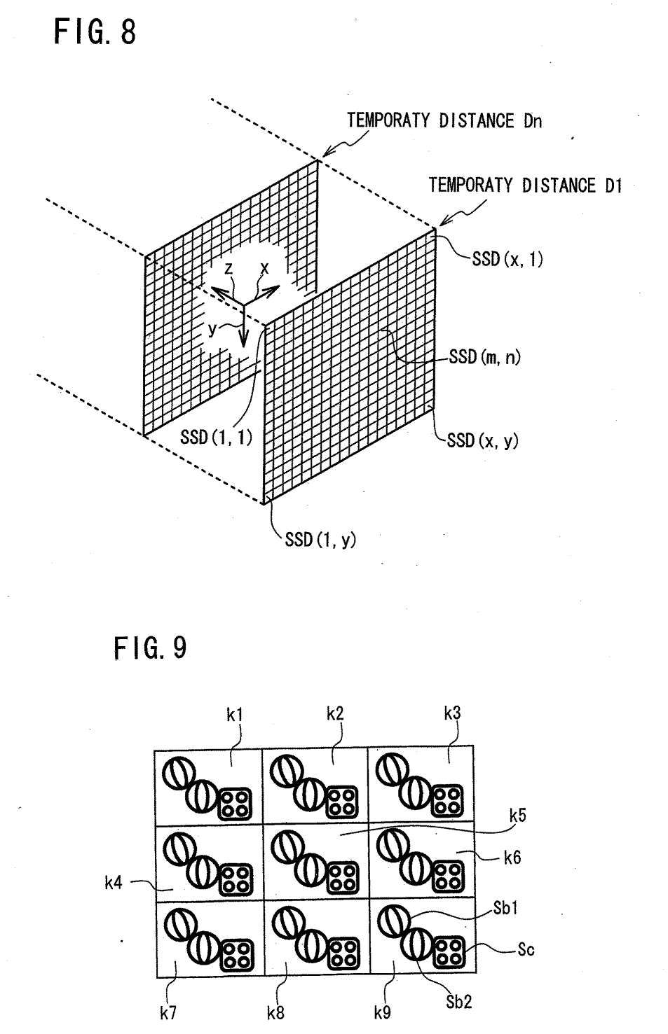

The microprocessor 4 repeats these steps until all the steps S1 to S4 for all the temporary distances D1 to Dn are completed, so as to obtain n evaluation values SSD(x,y) corresponding in number to the temporary distances D1 to Dn, and to store the group of n evaluation values SSD(x,y) e.g. in the memory 11. FIG. 8 schematically shows the group of evaluation values stored e.g. in the memory 11, storing the evaluation values SSD corresponding to the respective xy coordinate positions shown in FIG. 8. Thereafter, if the microprocessor 4 determines that the steps S1 to S4 for each of the temporary distances D1 to Dn have been completed to calculate the evaluation values SSD(x,y) for all the temporary distances D1 to Dn (YES in S5), the microprocessor 4 determines which one of the temporary distances D1 to Dn gives a minimum evaluation value SSD(x,y) among the evaluation values SSD(x,y) for the pixels g(x,y) at each xy coordinate position. The microprocessor 4 also determines that the temporary distance Di giving the minimum evaluation value SSD(x,y) is the object distance D for the pixel g(x,y) at each xy coordinate position (S6). In other words, the microprocessor 4 searches, in the z direction, the evaluation values SSD for each pixel g on the xy coordinate plane from the group of evaluation values shown in FIG. 8 so as to detect a temporary distance Di as an object distance D for each pixel g on the xy coordinate plane.

Finally, the microprocessor 4 creates a distance image (PD) which is formed of a difference in lightness/darkness of screen as obtained by converting the object distance D determined in S6 for each pixel g on the xy coordinate plane to a difference in lightness/darkness of screen (S7). An example of the created distance image (PD) will be described below. The created distance image (PD) is an image which accurately reflects the object distance D between the object and the imaging unit. Thus, particularly if the object is a three-dimensional object, an image with high definition which focuses on the object for all the pixels thereof can be easily created from the multiple unit images k1 to k9 by using the distance image (PD).

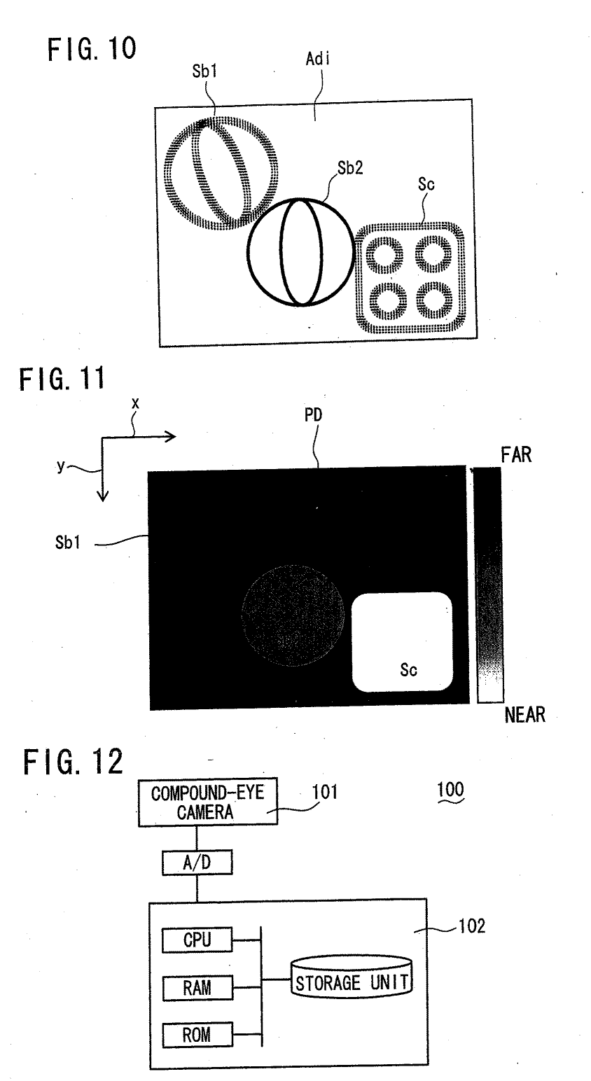

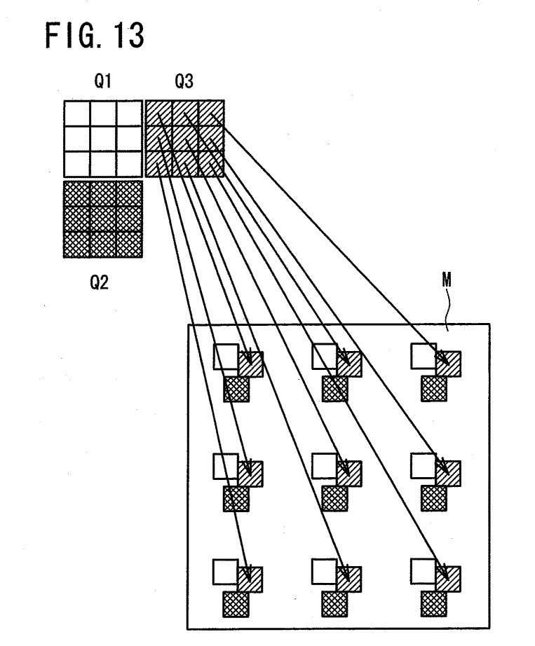

FIG. 9 is a schematic view showing an example of the unit images k1 to k9 captured by the compound-eye imaging unit 2 in the object distance deriving device 1, in which two spherical objects Sb1, Sb2 and one cubic object Sc as shown in FIG. 1 are used as objects to be captured. FIG. 10 is a schematic view showing an example of a reconstructed image Adi when one temporary distance Di is set in the object distance deriving device 1, in which the distance of the spherical object Sb1 from the compound-eye imaging unit 2 (optical lens array 6) is 53 cm, the distance therefrom of the spherical object Sb2 is 23 cm, and the distance therefrom of the cubic object Sc is 3 cm while the temporary distance Di is 23 cm. Further, FIG. 11 is a schematic view showing an example of a distance image PD as derived in step S7 described above in the object distance deriving device 1.

In the case of the reconstructed image Adi shown in FIG. 10, the temporary distance Di is set at a position equivalent to the distance (23 cm) of the spherical object Sb2 from the compound-eye imaging unit 2 (optical lens array 6). Thus, the image of the spherical object Sb2 is reconstructed with high definition, whereas the images of the spherical object Sb1 and the cubic object Sc are reconstructed with low definition. Further, in the distance image PD shown in FIG. 11, the spherical object Sb1 which is located far is displayed in a dark color, and the spherical object Sb2 located at an intermediate position is displayed in a light color, while the cubic object Sc located very near is displayed in a white color.

### Second Embodiment

An object distance deriving device 1 according to a second embodiment of the present invention is substantially the same as that of the first embodiment, except that in the second embodiment, the evaluation values SSD(x,y) as calculated in the evaluation value calculation step S4 in the flow chart of FIG. 3 are smoothed. More specifically, the microprocessor 4 applies a known smoothing filter to, and thereby smooths, the evaluation values SSD(x,y) as calculated in S4. By smoothing the calculation evaluation values SSD(x,y), the distribution of the evaluation values SSD(x,y) (smoothed evaluation values) on the XY plane becomes smooth (refer to FIG. 8), making it possible to more accurately derive the object distance by preventing an erroneous derivation of the object distance D due to determination of an improper temporary distance Di as the object distance D in the distance determining step S6. It is to be noted that the smoothing of the evaluation values SSD(x,y) can be performed such that immediately before the distance determining step S6, all the evaluation values SSD(x,y) for all the temporary distances D1 to Dn are smoothed together.

### Third Embodiment

An object distance deriving device 1 according to a third embodiment of the present invention is substantially the same as that of the first embodiment except for the following two points. The first point is that according to the third embodiment, in the reconstructed image creating step S2 in the flow chart of FIG. 3, the microprocessor 4 extracts a high-frequency component of each of unit images k1 to k9 so as to create each corresponding high-frequency component unit image, and then creates one high-frequency component reconstructed image Adi from the nine high-frequency component unit images by using the same method as described above. The second point is that according to the third embodiment, in the reverse projection image creating step S3, the microprocessor 4 extracts a high-frequency component of each of unit images k1 to k9 so as to create each corresponding high-frequency component unit image, and then creates nine high-frequency component reverse projection images Ardi1 to Ardi9 from the nine high-frequency component unit images by using the same method as described above. Here, in order to extract a high-frequency component of each of the unit images k1 to k9, the microprocessor 4 applies a known frequency filter to each of the unit images k1 to k9.

Generally, the unit images k1 to k9 captured by the compound-eye imaging unit 2 have a tendency such that more peripheral ones (e.g. unit images k1 to k9) of the unit images k1 to k9 are darker than the others, which may cause generation of a color with gradation across the entire unit images k1 to k9. Such problem is one occurring in a low-frequency component of each unit image, and can be referred to as low-frequency noise. Thus, such problem is eliminated in the high-frequency component unit images created by extracting the high-frequency components, and also eliminated in the high-frequency component reconstructed image Adi and the high-frequency component reverse projection images Ardi1 to Ardi9 created based on the high-frequency components, so that the microprocessor 4 can derive the object distance D more accurately.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on provisional patent application Ser. No. 60/986,117 filed Nov. 7, 2007, the content of which is hereby incorporated by reference.

What is claimed is:

1. An object distance deriving device comprising imaging means for capturing images of an object and distance calculating means for calculating a distance (hereafter referred to as “object distance”) of the object from the imaging means based on the images of the object captured by the imaging means,
wherein the imaging means has an optical imaging system for imaging n unit images each formed of pixels where n is an integer of at least 2, and
wherein the distance calculating means comprises:
distance setting means for temporarily setting a plurality of object distances between the object and the imaging means as a plurality of temporary distances;
reconstructed image creating means for rearranging the pixels forming each of the unit images on a plane located at a first one (hereafter referred to as “first temporary distance”) of the plurality of temporary distances from the imaging means as set by the distance setting means so as to create one reconstructed image on the plane located at the first temporary distance;
reverse projection image creating means for reversely projecting, unit image-by-unit image, the pixels forming each of the unit images on the plane located at the first temporary distance so as to create n reverse projection images on the plane located at the first temporary distance;
evaluation value calculating means for (a) calculating a deviation between a pixel at each predetermined xy coordinate position of the one reconstructed image and the pixel at the each predetermined xy coordinate position of each of the n reverse projection images to obtain n deviations for the pixel at the each predetermined xy coordinate position for the first temporary distance, and (b) summing the n deviations to calculate an evaluation value for the pixel at the each predetermined xy coordinate position for the first temporary distance;
repeating means for allowing the reconstructed image creating means, the reverse image creating means and the evaluation value calculating means to repeat, for each subsequent one of the plurality of temporary distances, the creation of a further reconstructed image of the n unit images, the creation of further n reverse projection images of the n unit images, and the calculation of a further evaluation value for the pixel at the each predetermined xy coordinate position, respectively, so as to obtain a plurality of evaluation values for the pixel at the each predetermined xy coordinate position for the plurality of temporary distances; and
distance determining means for determining, as the object distance for the pixel at the each predetermined xy coordinate position from the imaging means, one of the first and the subsequent temporary distances which gives a minimum evaluation value among the plurality of evaluation values for the pixel at the each predetermined xy coordinate position.

2. The object distance deriving device according to claim 1, wherein the distance calculating means further comprises smoothing means for smoothing the plurality of evaluation values for the pixel at the each predetermined xy coordinate position for the plurality of temporary distances as calculated by the evaluation value calculating means, and
wherein the distance determining means determines the object distance for the pixel at the each predetermined xy coordinate position from the imaging means based on the plurality of evaluation values as smoothed by the smoothing means.

3. The object distance deriving device according to claim 2, wherein the reconstructed image creating means creates n high-frequency component unit images by extracting a high-frequency component from each of the n unit images, and creates one high-frequency component reconstructed image from the thus created n high-frequency component unit images,
wherein the reverse projection image creating means creates n high-frequency component unit images by extracting a high-frequency component from each of the n unit images, and creates n high-frequency component reverse projection images from the thus created n high-frequency component unit images, and
wherein the evaluation value calculating means calculates the evaluation values based on the one high-frequency component reconstructed image and the n high-frequency component reverse projection images.

4. The object distance deriving device according to claim 1, wherein the reconstructed image creating means creates n high-frequency component unit images by extracting a high-frequency component from each of the n unit images, and creates one high-frequency component reconstructed image from the thus created n high-frequency component unit images,
wherein the reverse projection image creating means creates n high-frequency component unit images by extracting a high-frequency component from each of the n unit images, and creates n high-frequency component reverse projection images from the thus created n high-frequency component unit images, and
wherein the evaluation value calculating means calculates the evaluation values based on the one high-frequency component reconstructed image and the n high-frequency component reverse projection images.
